(19) United States
(12) Patent Application Publication
(10) Pub. No.: US 2008/0087304 A1
(43) Pub. Date: Apr. 17, 2008

(54) SYSTEM AND METHOD FOR PROCESSING A SUBSTRATE UTILIZING A GAS STREAM FOR PARTICLE REMOVAL

(76) Inventors: Cole Franklin, San Clemente, CA (US); Mark Roullard, Mission Viejo, CA (US); Yan Fan, San Diego, CA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/841,427

(22) Filed: Aug. 20, 2007

Related U.S. Application Data
(60) Provisional application No. 60/889,633, filed on Feb. 13, 2007.
(60) Provisional application No. 60/850,240, filed on Oct. 6, 2006.
(60) Provisional application No. 60/838,566, filed on Aug. 18, 2006.

(51) Int. Cl. B08B 3/10; B08B 3/12

(52) U.S. Cl. 134/33; 134/153; 134/34; 134/37

(57) ABSTRACT

A system and method of processing a substrate. The method and system applies a liquid to a surface of the substrate so as to form a film of the liquid on the surface of the substrate, wherein a boundary layer exists at the interface of the surface and the film of the liquid. The cleaning system then applies a force that penetrates the boundary layer so as to create a localized area on the surface of the substrate that is substantially free of the liquid. The application of the force in combination with the liquid removes particles from the surface of the substrate.

### CROSS-REFERENCE TO RELATED APPLICATIONS

The present application claims the benefit of U.S. Provisional Application No. 60/889,633, filed Feb. 13, 2007, U.S. Provisional Application No. 60/850,240, filed Oct. 6, 2006, and U.S. Provisional Application No. 60/838,566, filed Aug. 18, 2006, the entireties of which are hereby incorporated by reference.

### FIELD OF INVENTION

The present invention relates generally to the field of processing substrates, and specifically to methods and systems for cleaning substrates, such as semiconductor wafers.

### BACKGROUND OF THE INVENTION

In the manufacture of semiconductor devices, thin disk-like objects are produced, typically called wafers. Generally, each wafer contains a plurality of semiconductor devices. The importance of minimizing contaminants on the surface of these wafers during production has been recognized since the beginning of the industry. Moreover, as semiconductor devices become more miniaturized and complex due to end product needs, the cleanliness requirements have become more stringent.

As devices become miniaturized, a contaminating particle on a substrate will occupy a greater percentage of the device's surface area. This increases the likelihood that the device will fail. As such, in order to maintain acceptable output levels of properly functioning devices per wafer, increased cleanliness requirements must be implemented and achieved. Additionally, as devices become more complex, the raw materials, time, equipment, and processing steps necessary to make these devices also become more complex and more expensive. As a result, the cost required to make each wafer increases. In order to maintain acceptable levels of profitability, it is imperative to manufacturers that the number of properly functioning devices per substrate be increased. One way to increase this output is to minimize the number of devices that fail due to contamination. Thus, increased cleanliness requirements are desired.

### SUMMARY OF INVENTION

It is therefore an object of the present invention to provide an improved substrate processing system and method to remove particles from the surface of a substrate.

It is yet another object of the present invention to provide a substrate cleaning system and method for removing particles from a semiconductor wafer.

It is a further object of the present invention to provide a substrate cleaning system and method of for removing particles trapped in a boundary layer of cleaning fluid on a surface of a substrate.

A yet further object of the present invention is to provide a substrate cleaning system and method that reduces operating costs.

Another object of the present invention is to provide a substrate cleaning system and method that reduces damage to devices on a semiconductor wafer while improving particle removal efficiency.

These and other objects are met by the present invention, which in one aspect can be a method of processing a substrate comprising the steps of: a) supporting a substrate on a rotary support; b) rotating the substrate about a rotational center-point; c) applying a liquid to a surface of the substrate so as to form a film of the liquid on the surface of the substrate, wherein a boundary layer exists at the interface of the surface and the film of the liquid; and d) applying a stream of gas to penetrate the boundary layer so as to create a localized area on the surface of the substrate that is substantially free of the liquid, the localized area being surrounded by the film of liquid.

In another aspect, the invention can be a method for cleaning a semiconductor wafer comprising: a) supporting a semiconductor wafer in a substantially horizontal orientation; b) rotating the semiconductor wafer; c) applying a liquid to a surface of the substrate so as to form a film of the liquid on the surface of the substrate, wherein a boundary layer exists at the interface of the surface and the film of the liquid; d) applying sonic energy to the surface of the substrate so as to loosen particles located on the surface of the substrate; and e) applying a stream of gas that penetrates the boundary layer so as to create a localized area on the surface of the substrate that is substantially free of the liquid, the localized area being surrounded by the film of the liquid and dislodging the particles away from the surface of the substrate.

In another aspect the invention can be a system for processing a substrate comprising: a rotary support for supporting a substrate; a first dispenser adapted to apply a liquid to a surface of the substrate so as to form a film of the liquid on the surface of the substrate, wherein a boundary layer exists at the interface of the surface of the substrate and the film of the liquid; and a second dispenser adapted to supply a stream of gas and having an outlet, the second dispenser positioned so that the outlet is sufficiently close to the surface of the substrate so that the stream of gas penetrates the boundary layer so as to create a localized area on the surface of the substrate that is substantially free of the liquid, the localized area being surrounded by the film of liquid.

In another aspect, the invention can be a system for processing a substrate comprising: a rotary support for supporting a substrate; a first dispenser adapted to apply a liquid to a surface of the substrate so as to form a film of the liquid on the surface of the substrate, wherein a boundary layer exists at the interface of the surface of the substrate and the film of the liquid; and a second dispenser adapted to apply a localized suction force and having an opening, the second dispenser positioned so that the opening is sufficiently close to the surface of the substrate so that the opening is contact with the film of liquid.

### BRIEF DESCRIPTION OF DRAWINGS

FIG. 1 is a schematic of a cleaning system according to one embodiment of the present invention.

FIG. 2a is a front perspective view of a cleaning assembly according to one embodiment of the present invention.

FIG. 2b is a rear perspective view of the cleaning assembly of FIG. 2a.

FIG. 3a is a schematic of a gas stream being applied to the surface of a blank substrate to create a localized area in a film of liquid that is substantially free of liquid, according to one embodiment of the present invention.

FIGS. 4a-4c are schematics of a gas stream being applied to a surface of a semiconductor wafer at various positions according to one embodiment of the present invention.

FIG. 5 is a schematic of a cleaning system according to a second embodiment of the present invention, wherein the system has megasonic processing capabilities.

FIG. 6 is a schematic of a cleaning system having a cleaning assembly having a gas dispenser positioned adjacent to a liquid dispenser, according to another embodiment of the present invention.

FIG. 7 is a schematic of a top view of a substrate being processed by the cleaning assembly of FIG. 7.

FIG. 8 is a schematic of a cleaning system having a cleaning assembly wherein the gas dispenser is angled and adjacent to a liquid dispenser, according to another embodiment of the present invention.

FIG. 9 is a schematic of a cleaning system having a cleaning assembly wherein the gas dispenser is angled and adjacent a liquid dispenser, according to another embodiment of the present invention.

FIG. 10 is a schematic of a cleaning system having a cleaning assembly having an angled gas dispenser and two liquid dispensers adjacent thereto, according to another embodiment of the present invention.

FIG. 11 is a schematic of a cleaning system having a cleaning assembly having a gas dispenser and two liquid dispensers, according to another embodiment of the present invention.

FIG. 12a is a schematic of a cleaning assembly having a liquid dispenser circumferentially surrounding a gas dispenser, according to another embodiment of the present invention.

FIG. 12b is a schematic of a substrate being processing using the cleaning assembly of FIG. 12b.

FIG. 13 is a schematic of a cleaning assembly utilizing a suction force according to another embodiment of the present invention.

### DETAILED DESCRIPTION OF THE DRAWINGS

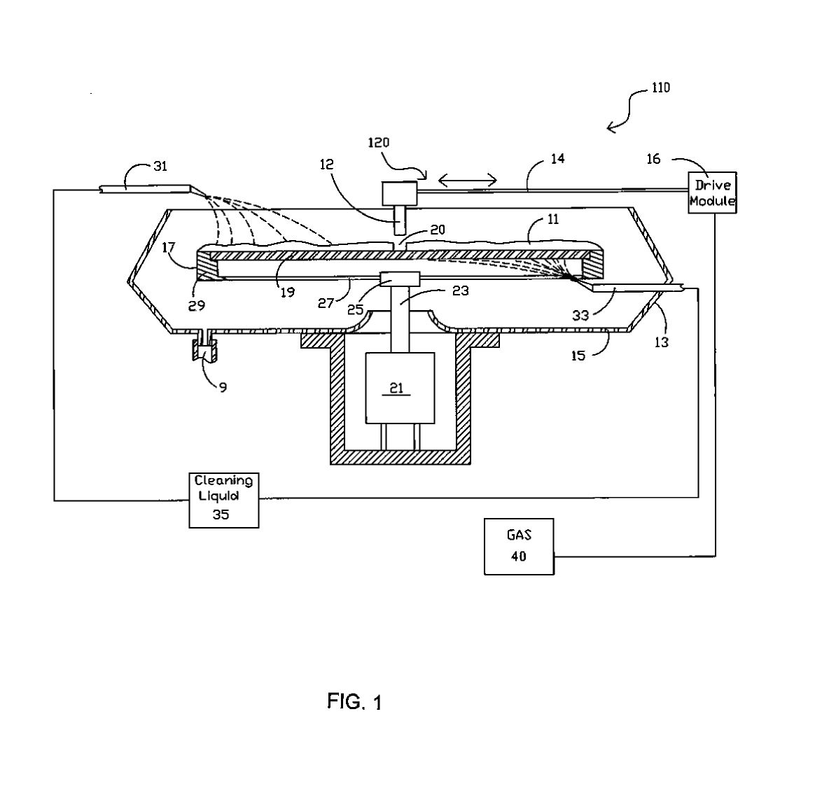

FIG. 1 illustrates a cleaning system 110 according to one embodiment of the present invention. The cleaning system 110 supports a substrate 19 is supported in a substantially horizontal orientation and rotates the substrate 19 while a film of liquid 11 is applied to one or both sides/surfaces of the substrate 19. The rotation of the substrate 19 is intended to force the fluid 11 and any loosened particles off of the substrate via centrifugal force. In general, when liquid comes into contact with a solid, a boundary layer is formed at the interface between the liquid and the solid. A characteristic of fluid flow is that the fluid has zero velocity at the boundary layer, i.e. the fluid does not slip at the boundary with a solid. Therefore, despite the velocity of the liquid at the top of the film of liquid 11 relative to the substrate 19 being non-zero, the relative velocity between the liquid 11 and the substrate 19 is zero at the surface of the substrate 19. The macroscopic effect is that particles on the surface of the substrate 19 become entrapped in the film of liquid 11 because the liquid at the boundary layer is not traveling off of the substrate 19. Additionally, when the substrate 19 is a semiconductor wafer having devices on its surface, the entrapment of particles is increased due to the topography on the wafer surface. More specifically, the devices are positioned on the semiconductor wafer so that they are spaced from each other, thereby forming gaps/spaces between the devices (commonly referred to as trenches) that act as channels in which particles remain trapped. In one embodiment, the present invention provides for a localized application of a gas stream, that acts as a source of pressure, to penetrate through the boundary layer of the film of fluid 11, to effectuate the removal of particles that may be trapped at the wafer surface and/or in the trenches. In another embodiment, the invention provides for localized suction, that acts as a negative pressure, to break the boundary layer. The present invention is particularly beneficial for use with semiconductor wafers that have trenches having a width less than 90 nm, but it is no way limited those semiconductor wafers.

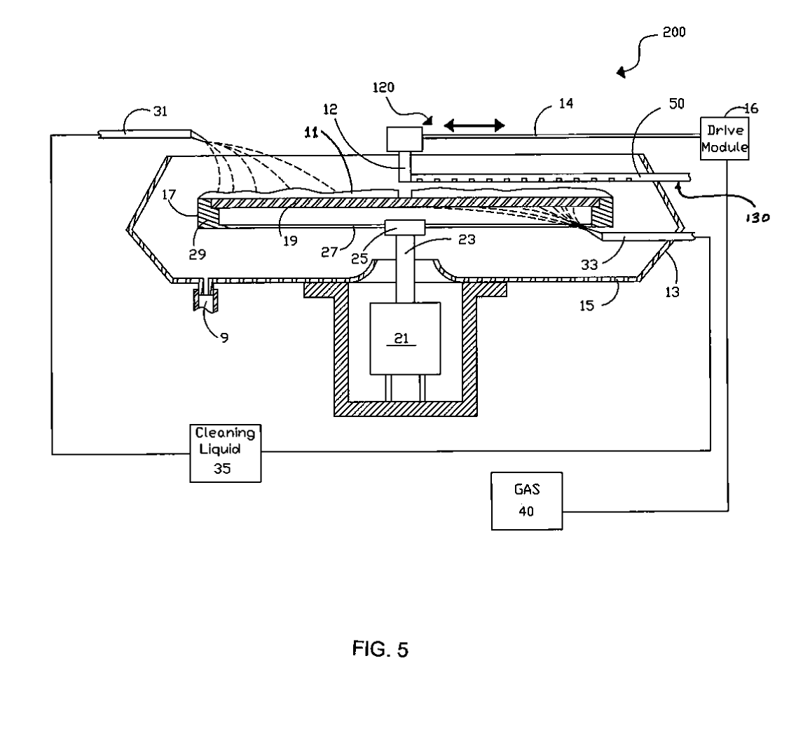

Referring to FIG. 1, the cleaning system 110 generally comprises a process chamber 13, a gas source 40, a cleaning assembly 120, a liquid source 35, and a top dispenser 31. While the system and methods of the present invention are exemplified as a single-wafer non-immersion system, the invention is not so limited. Additionally, as will be discussed in further detail below with respect to FIG. 5, the concepts and ideas discussed herein can be incorporated into other styles of single-wafer cleaning systems, including systems that use sonic energy to effectuate cleaning.

The process chamber 13 of the cleaning system 110 comprises a tank 15 inside of which is disposed a support 17 adapted to support and/or securely hold a substrate 19. The substrate 19 may be a semiconductor wafer or other flat article that requires a high level of cleanliness. The process chamber 13 supports the substrate 19 in a gaseous atmosphere, such as air, nitrogen, or other gases. As used herein, the term “process chamber” is used to refer to any volume of space in which a substrate 19 can be processed; it does not require any specific wall arrangement and/or structural arrangement.

The support 17 generally comprises a motor 21, a shaft 23, a hub 25, spokes 27, and an annular rim 29. The rim 29 supports the substrate 19 in a substantially horizontal orientation as it is rotated about a generally vertical axis by the motor 21, in cooperation with the shaft 23, the hub 25, and the spokes 27. The motor 21 is preferably a variable speed motor that can rotate the support 18 at any desired rotational speed. The motor 21 is electrically and operably coupled to a controller, which controls the operation of the motor 21, ensuring that the desired rotational speed and desired duration of rotation are achieved.

The top dispenser or nozzle 31 is positioned so as to dispense a liquid onto the top surface of the substrate 19, thereby forming a layer 11 of the liquid on the top surface of the substrate 19. The bottom dispenser 33 is positioned to dispense a liquid onto the backside of the substrate 19. As used herein, the term “liquid” may be used to refer to any liquid, liquid mixture, or liquid-gas solution, and the like. Typically, the liquid being applied to the substrate is a cleaning chemical agent such as ammonia, SC1, SC2, deionized (DI) water, TMAH, oxalic acid, acetic acid, organic solvents, and combinations and diluted versions thereof or some other chemical that is typically used in the cleaning of a substrate surface. The dispensers 31, 33 can apply the liquid to the substrate 19 via a laminar or turbulent fluid flow or a spraying action. A drain line 9 in the lower end of the tank 15 permits accumulated liquid to exit therefrom.

All components of the liquid supply system are operatively and fluidly coupled to each other and to the dispensers 31, 33. While not illustrated, the necessary valves, pumps, sensors, etc. are incorporated into the liquid supply system. A detailed explanation of these components is not necessary, as this knowledge is well within the level of those ordinarily skilled in the art. The liquid source 35 will contain the liquid that is applied to the substrate 19. In other embodiments, the liquid supply system may be adapted to mix multiple liquids for supply to the substrate 19 as a liquid mixture. It should be further understood that more than one liquid source 35 can be used when more than one type of liquid is being used. Furthermore, the liquid source 35 and/or dispensers 31, 33 may contain heating elements so that the liquid that is applied to the substrate 19 may be heated above ambient room temperature. The liquid supply system is operably connected to and controlled by a system controller (not illustrated).

The controller will control and regulate the flow of liquid for the cleaning system 110 through operable and electrical connections to the pumps, valves, sensors, etc. The electrical connections between the controller and the liquid supply system's components are provided as necessary. The controller can be a suitable microprocessor based programmable logic controller, personal computer, or the like for process control. The controller can communicate with the various components of the liquid supply system to automatically adjust and maintain process conditions, such as the temperature of the liquid, flow rates, application of gas, etc. The controller preferably includes various input/output ports used to provide connections to the various other components of the cleaning system 110 that need to be controlled and/or communicated with. The controller also preferably comprises sufficient memory to store process recipes and other data, such as thresholds inputted by an operator, processing times, processing conditions, processing temperatures, flow rates, desired concentrations, sequence operations, and the like. The type of system controller used for any given system will depend on the exact needs of the system in which it is incorporated.

The cleaning assembly 120 comprises a gas dispenser 12, a support member 14 and a drive module 16. The gas dispenser 12 is oriented normal to the surface of the substrate 19. However, it should be understood that the gas dispenser 12 may be oriented at an angle with respect to the surface of the substrate 19 and that a plurality of gas dispensers 12 may be used if desired. As discussed in further detail below, the dispensing end of the gas dispenser 12 is positioned sufficiently near the top surface of the substrate 19 so that the pressure of the applied gas can penetrate the boundary layer of the film of liquid 11. Preferably, the gas dispenser 12 is positioned so that its opening is between 5 mm and 10 mm above the top surface of the substrate 19.

The support member 14 of the gas assembly 120 is oriented parallel to the top surface of the substrate 19. The gas dispenser 12 and the support member 14 are operably connected to the drive module 16. The drive module 16 moves the support member 14 and the gas dispenser 12 with respect to the substrate 15. The drive module 16 is operably connected to the controller discussed above. An opening may be provided in the tank 15 to permit the gas dispenser 12 to move into and out of the tank 16. This allows insertion/removal of the substrates 19 from the support 17. The retractability of the gas dispenser 12 further allows for the position of the gas dispenser 12 relative to the top surface of the substrate 19 to be continually changed. For example, the gas dispenser 12 may be moved between a position above the rotational central axis of the substrate 19 to a position above the edge of the substrate 19, thereby achieving a sweeping motion. The sweep motion is performed through the use of the support member 130 and the drive module 16. Additionally, the support member 14 may be located within the tank 15, and the opening in the well of the tank 15 may accommodate both the support member 14 and the gas dispenser 12, if desired.

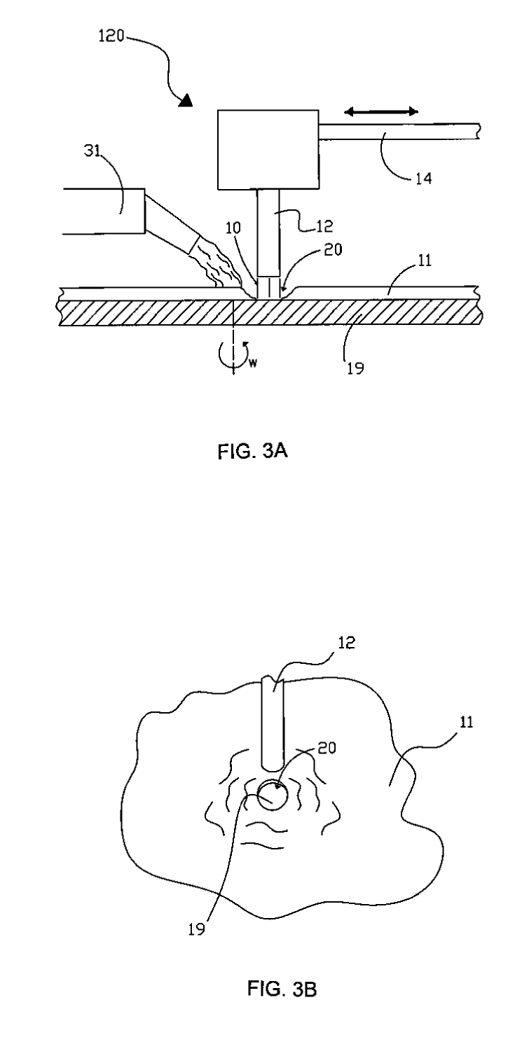

The gas source 40 is operatively coupled to the gas dispenser 12 and dispenses a gas 10 (shown in FIG. 3a) in the direction of the surface of the substrate 19 and through the film of liquid 11 in order to create a localized area 20 that is substantially devoid of any liquid 11. As used herein, the term “gas” may be used to refer to any gas, non-reactive gas, gaseous mixture, vapor, and combinations thereof. Examples of suitable gases that may be dispensed include, without limitation, NH₃, N₂, O₂, He, Ar, air, CO₂, O₃ and the like. The exact liquid and/or gas used will depend on the cleaning process being performed, the type of substrate 19 being processed, the size of the devices on the substrate 19, and the susceptibility of the devices to damage. In other embodiments, the gas supply system may be adapted to mix multiple gases for supply to the substrate 19 as a gas mixture. It should be further understood that more than one gas source 40 can be used when more than one type of gas is being used. Furthermore, either the gas source 40, the gas dispenser 12 or the gas supply line may be provided with heating elements in order to heat the gas before applying it to the surface of the substrate 19. Additionally, separate heating devices, such as a heater, may be used for heating the gas before it reaches the surface of the substrate 19.

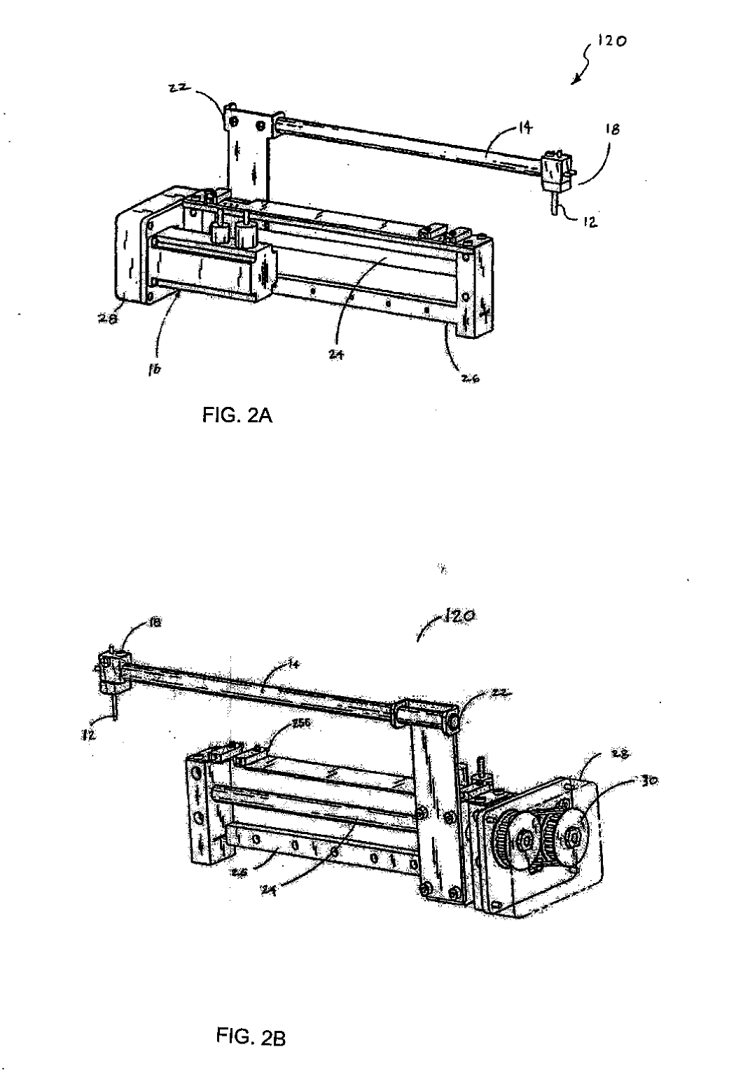

Referring now to FIGS. 2a and 2b the cleaning assembly 120 is illustrated removed from the cleaning system 110 with the details of the drive module 16. The drive module 16 is connected to the support member 14 which is operably connected to the gas dispenser 12. The gas dispenser 12 is operably connected to the support head 18. The support head 18 may be adapted to be adjusted so as to direct the dispensed gas 10 (shown in FIG. 3a) at an angle with respect to the surface of the substrate 19 if so desired.

The support member 14 is connected to the support base 22, which is part of the drive module 16. The drive module 16 further comprises the drive shaft 24 and the drive rail 26 on which the support base 22 is moved and guided. The support base 22 is operably connected to the gear housing 28 and the gear assembly 30. In operation, the controller sends signals to the drive module 16, which operates the gear assembly 30. The drive module 16 operates to move the gas dispenser 12 across the surface of the substrate 19.

Referring now to FIGS. 3a and 3b, the general mechanism of action of the cleaning system 110 will be described. As discussed above, the substrate 19 is supported in a substantially horizontal orientation. A liquid 11 is then applied to the top surface of the substrate so as to form a film of the liquid 11 on the surface of the substrate 19. Naturally, a boundary layer exists at the interface of the surface of the substrate 19 and the film of the liquid 11. The cleaning assembly 120 applies a stream of gas 10 to the top surface of the substrate 19 to penetrate the boundary layer of the film of liquid 11 so as to create a localized area 20 on the surface of the substrate 19 that is substantially free of the liquid 11. The localized area 20 is surrounded by the remaining film of liquid 11. The gas stream 10 is applied at a pressure that is sufficient to penetrate the fluid boundary layer of the liquid 11. The necessary pressure at which the gas 10 is to be applied will vary depending upon overall structure of the cleaning assembly 120, the size of the nozzle/opening of the gas dispenser 12, the distance between the substrate 19 and the gas dispenser 12, with the density of the gas and/or liquid being used, etc. Preferably, the pressure will be between 5 L/min and 40 L/min. However, as will be discussed in more detail below, the pressure necessary for breaking through the boundary layer is also dependent upon the rotational speed \acute{ω} of the substrate 19.

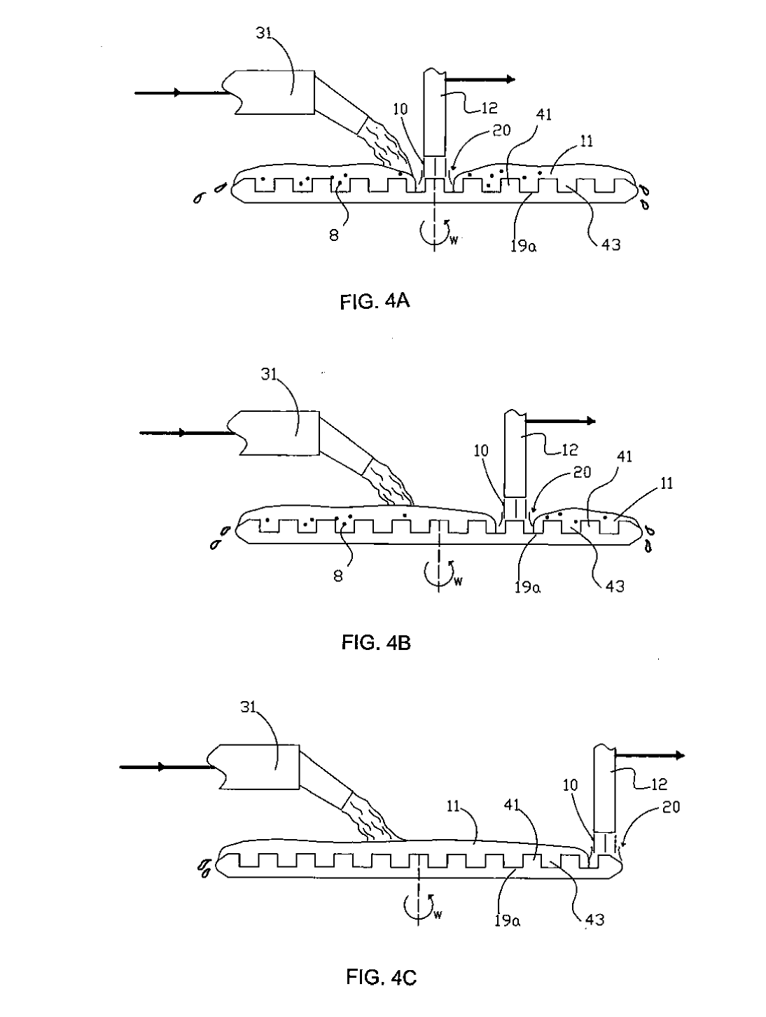

Referring to FIGS. 1 and 4a-4c concurrently, a method of using the cleaning system 110 to remove the particles 8 off of the surface of a substrate 19a will be discussed. The substrate 19a comprises a plurality of nodes 41, that may be devices on a semiconductor wafer. Between each pair of nodes 41 is a trench 43. The particles 8 are located both on the nodes 41 and within the trenches 43.

The substrate 19a is first supported on the rotary support 17. The substrate 19a is then rotated about a rotational center-point and liquid is applied to the top surface of the substrate 19a, thereby creating a film of liquid 11 on the substrate 19a. The liquid dispenser 31 is used to dispense the liquid 11 onto the surface of the substrate 19a. The liquid 11 may be a layer of 100:1 ammonia that is at ambient temperature. The invention is not so limited however, and other liquids 11 may be used including, without limitation, SC1 and DI water. Furthermore, the liquid 11 may be heated before being applied to the surface of the substrate 19b. Preferably, the liquid is heated from between 20° C. (or from a temperature at which the liquid is not a solid) to 100° C. (or to a temperature at which the liquid is not a gas). The appropriate range of temperatures will vary depending upon the physical properties of the liquid 11 that is used in the cleaning process. For example, when using SC1, it is preferable that the liquid be heated to 60° C.

The rotation of the substrate 19a and the positioning of the dispenser 31 results in the entire surface of the substrate 19a being covered by the film of liquid 11. As discussed previously, a boundary layer is formed at the interface between the liquid 11 and the surface of the substrate 19a. The gas dispenser 12 is then activated, thereby applying a stream of gas 10 that penetrates the boundary layer, thereby creating a localized area 20 on the surface of the substrate 19a that is substantially free of the liquid 11. The creation of the localized area 20 increases the local dipole moment and creates a surface tension gradient and drag force on the particles 8. The particles 8 are pushed away from the surface of the substrate 19a by the gas 10 and into the liquid 11 that is moving relative to the wafer surface. The particles 8 are then removed from the substrate 19a as the liquid 11 carries the particles 8 away from the cleaned area. The gas 12 may be heated before being applied to the substrate 19a so as to further increase the dipole moment and drag of the liquid 11, thereby further decreasing the surface tension. The dipole moment and drag forces additionally serve to keep the particles 8 in suspension, thereby preventing reattachment to the surface of the substrate 19a. The gas 10 may also be heated prior to being applied to the surface of the substrate 19a. When the gas 10 used is nitrogen, it is preferable to heat the gas 10 to a temperature between 20° C. and 115° C., and most preferably to about 60° C. The invention is not so limited, however, and the temperature of the gas will vary depending upon the gas used and the desired performance.

As mentioned above, the rotational speed \acute{ω} of the substrate 19a affects the ease with which the gas 10 is able to penetrate the fluid boundary layer. Preferably, the substrate 19a is rotated at a speed \acute{ω} below 500 RPMs and is preferably kept below 150 RPMs. Most preferably the speed \acute{ω} is between 5-50 RPMs. By keeping the rotation of the substrate 19a at a sufficiently low rate, the fluid boundary layer is more easily penetrated and the substrate 19a is kept from drying too quickly. When increasing the rotational speed \acute{ω} of substrate 19a, it is necessary to correspondingly increase the flow rate of the gas 10 in order to achieve the same level of fluid boundary penetration. Thus, reducing the rotational speed means that the pressure of the gas 10 may be kept lower, thereby reducing operating costs and reducing the risk of device damage. The application rate of the gas 10 is preferably between 5 L/min and 40 L/min, and more preferably between 5 L/min and 15 L/min. The invention is not so limited however, and when other gases are used, the flow rate will vary depending upon the properties of the gas being used.

To clean the entire surface area of the substrate 19a, the gas dispenser 12 may be translated across the top surface of the substrate in a radial direction. FIG. 4a shows an initial position of the gas dispenser 12 over the substrate 19a. The gas dispenser 12 is positioned at the central axis of the substrate 19a, (i.e., over the rotational center point of the substrate 19a). The gas dispenser 12 dispenses the gas stream 10 and pushes the particles 8 out of the trenches 43 formed between the nodes 41 and away from the localized area 20. During the operation of the cleaning assembly 120 when the gas dispenser 12 is at the center-point of the substrate 19a, the liquid dispenser 31 may be shut off. The gas dispenser 12 is then moved toward the perimeter/edge of the substrate 19a and the liquid dispenser 31 is turned on again. This is done in order to avoid the collision or crossing of the stream of liquid 11 and the stream of gas 10.

When moving the gas dispenser 12 towards the edge of the substrate 19a (or back and forth between the edge and the rotational center-point of the substrate 19a), the cleaning process is uniformly applied to the surface of the substrate 19a. When the speed \acute{ω} of rotation of the substrate 19a remains constant, the translation of the gas dispenser 12 is slowed as it moves towards the edge of the substrate 19a in order to ensure that the entire surface of the substrate 19a is subjected to the localized area 20.

The operation of the above method results in dislodging the particles 8 from the surface of the substrate 19a and pushing the particle 18 away from the surface of the substrate 19a. As the gas dispenser 12 continues to move across the surface of the substrate 19a toward the edge, the particles 8 are also forced toward the edge of the substrate 19a. As shown in FIG. 4c, the movement of the gas dispenser 12 eventually operates to remove the particles 8 from the surface of the substrate 19a. Through the operation of these forces, the particles 8 are removed from the trenches 43 better than if the liquid 11 were used by itself.

Referring to FIG. 5, a cleaning system 200 is illustrated according to another embodiment of the present invention. The cleaning system 200 is substantially similar to the cleaning system 110. Therefore, in order to avoid redundancy, only those aspects of the cleaning system 200 that substantially differ will be discussed. The cleaning system 200 comprises the cleaning assembly 120 and a sonic cleaning assembly 130. The sonic cleaning assembly 130 is a rod like transducer assembly used to apply megasonic energy to the surface of the substrate 19a. The invention is not limited to a rod like transducer assembly however, and other systems may be used including a plate-like transducer assembly, a lens style transducer assembly, or a pie-shaped transducer assembly. Such transducer assemblies and single-wafer cleaning systems that utilize megasonic energy are disclosed, for example in U.S. Pat. No. 6,039,059 (“Bran”), issued Mar. 21, 2000, and U.S. Pat. No. 7,100,304 (“Lauerhaas et al.”), issued Sep. 5, 2006, the entireties of which are hereby incorporated by reference herein. The single-wafer cleaning system that is the subject of U.S. Pat. No. 6,039,059 and U.S. Pat. No. 7,100,304 is commercialized by Akrion, Inc. of Allentown, Pa. under the name “Goldfinger®.” Other examples of single-wafer cleaners that utilize acoustic energy are disclosed in U.S. Pat. No. 7,145,286 (“Beck et al.”), issued Dec. 5, 2006, U.S. Pat. No. 6,539,952 (“Itzkowitz”), issued Apr. 1, 2003, and U.S. Patent Application Publication 2006/0278253 (“Verhaverbeke et al.”), published Dec. 14, 2006.

In the cleaning system 200, a substrate 19 is supported and rotated in horizontal orientation while a film of liquid 11 is applied to one or both sides/surfaces of the wafer. A transducer assembly is positioned adjacent to one of the surfaces of the wafer 19b so that a transmitter portion 50 of the transducer assembly is in contact with the film of liquid 11 by a meniscus of the liquid. The transducer assembly is activated during the rotation of the substrate 19, thereby subjecting the wafer to the sonic energy generated by the transducer assembly. The sonic energy serves to loosen particles on the surface of the wafer 19b.

The transducer assembly may be used either concurrently with, before, or in an alternating fashion with the cleaning assembly 120. When used in an alternating fashion, megasonic energy is applied to the substrate 19a through the fluid 11 for a period of time so as to loosen particles from the surface of the substrate 19a. The application of sonic energy is then stopped. A stream of gas 10 may then be applied via the cleaning assembly 120 to remove the particles away from the surface of the substrate 19a, as discussed above with respect to FIGS. 4a-4c for a period of time. Megasonic energy may then be reapplied and so on, in a repetitive cycling fashion.

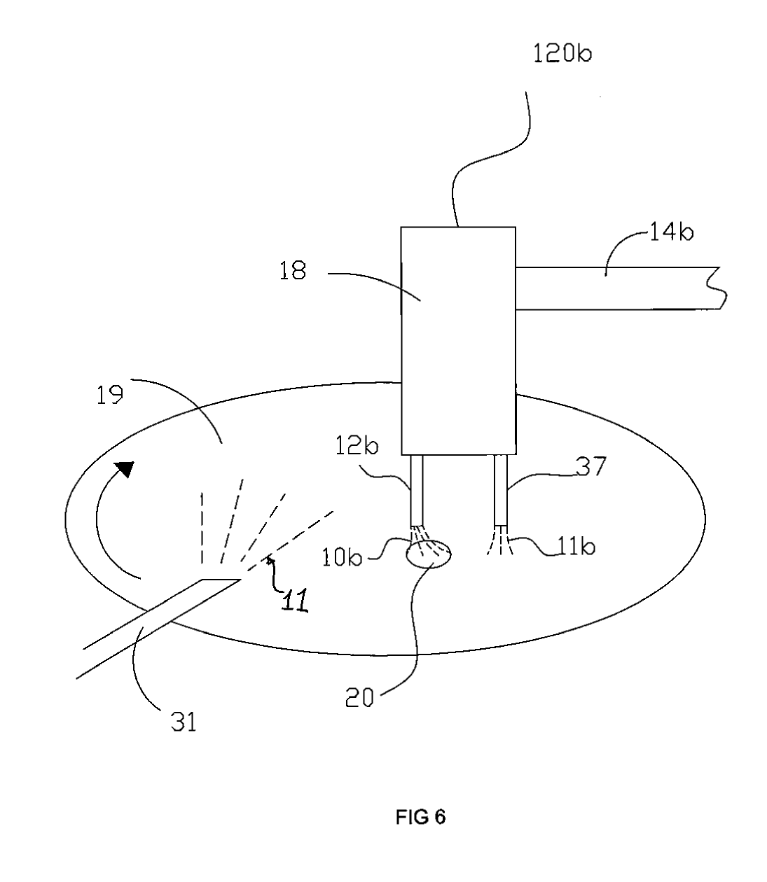

Now turning to FIG. 6, a cleaning assembly 120b is illustrated, according to an alternative embodiment of the present invention. The cleaning assembly 120b operates in the same manner as the cleaning assembly 120 discussed above and can be incorporated into the larger system 110. In order to avoid redundancy, only the differences between the embodiments will be discussed. The cleaning assembly 120b comprises a liquid dispenser 37 and a gas dispenser 12b. The liquid dispenser 37 applies a stream of liquid 11b to the surface of the substrate 19 to keep the substrate 19 from becoming dry. The liquid dispenser 37 may be used in conjunction with the top dispenser 31 or in lieu of it. The liquid dispenser 37 is attached to the support head 18 and is oriented normal to the surface of the substrate 19.

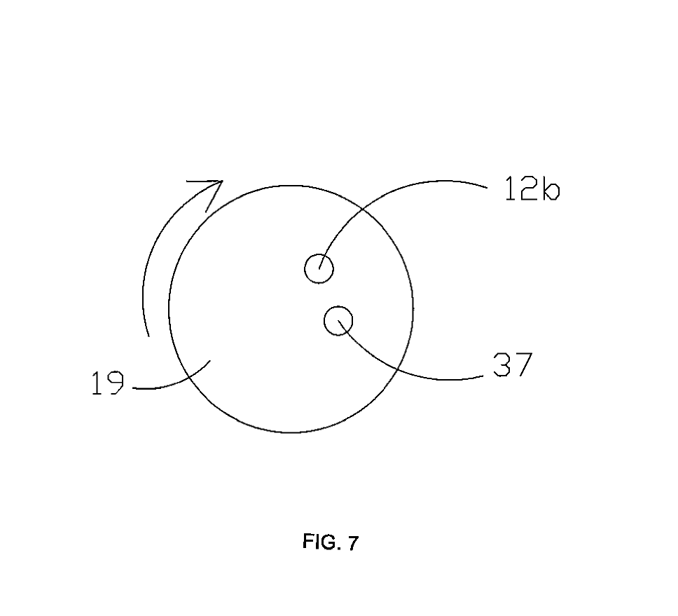

Now turning to FIG. 7, an illustration of the cleaning assembly 120b shows the relative positioning of the liquid dispenser 37 and the gas dispenser 12b. The liquid dispenser leads the gas dispenser 12b in the direction of rotation of the substrate 19 so that the liquid 11 is dispensed onto the surface of the substrate 19 prior to the dispensing of the gas 10b. The substrate 19 is rotated in a clockwise direction as indicated by the arrow. When positioned in this manner the liquid dispenser 37 and gas dispenser 12b are located along the perimeter of a circle that is concentric with the substrate 19. In other words, the distance from the central axis (i.e., the rotational center-point) of the substrate 19 to the liquid dispenser 37 is equal to the distance from the central axis (i.e., the rotational center-point) of the substrate 19 to the gas dispenser 12b. The liquid dispenser 37 and the gas dispenser 12b are spaced sufficiently from each other along the circumference of circle so that the flow of liquid 11 is a laminar flow in order to have better control of the process. This permits the particles 8 that are dislodged from the surface of the substrate and out of the trenches 43 to be displaced by the incoming flow.

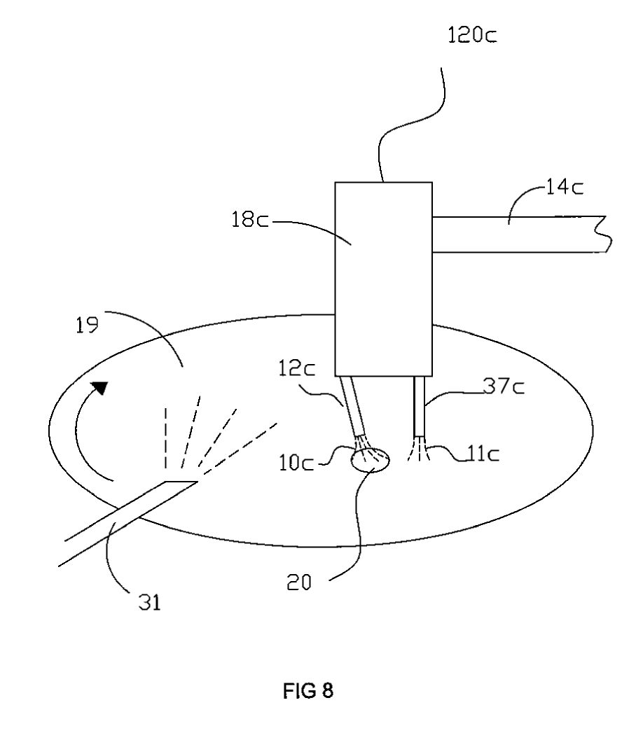

Now turning to FIG. 8, a cleaning assembly 120c is illustrated according to another embodiment of the present invention. The cleaning assembly 120c comprises a liquid dispenser 37c and a gas dispenser 12c positioned adjacent thereto. The gas dispenser 12c is oriented at a non-normal angle with respect to the horizontal surface of the substrate 19 so that the gas 10c is dispensed in a direction away from the central axis of the substrate 19. The angle of the stream of gas 10c results in a force being applied to the particles 8 in a non-perpendicular orientation with respect to the top surface of the substrate 19. The liquid dispenser 37c is placed closer to the perimeter of the substrate 19 than is the gas dispenser 12c so that the liquid 11 is dispensed onto the surface of the substrate 19 prior to the dispensing of the gas 10c. Alternatively, the liquid dispenser 37c is placed forward of the gas dispenser 12c (in the direction of rotation of the substrate 19).

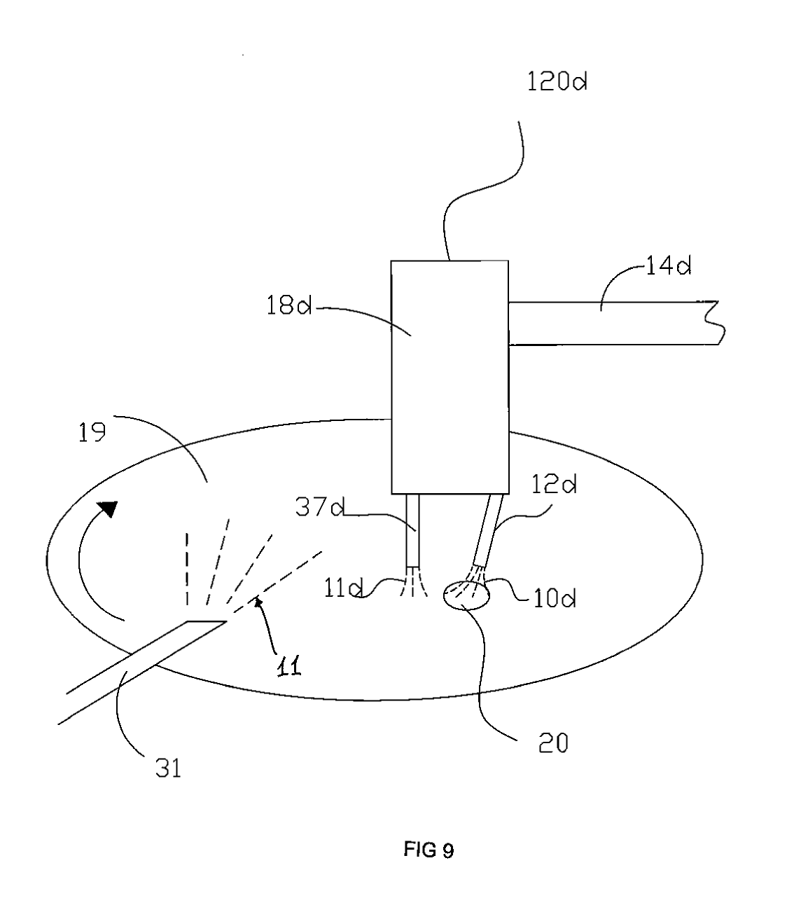

Now turning to FIG. 9, a cleaning assembly 120d is illustrated according to another embodiment of the present invention. The cleaning assembly 120d comprises a liquid dispenser 37d and a gas dispenser 12d, positioned adjacent thereto. The gas dispenser 12d is angled with respect to the top surface of the substrate 19 so that the gas 12d is dispensed in the direction towards the central axis of the substrate 19 at a non-normal orientation. The liquid dispenser 37d is placed behind the gas dispenser 12d with respect to the rotational direction of the substrate 19. Therefore, the gas 10d is dispensed onto the surface of the substrate 19 prior to the dispensing of the liquid 11d .

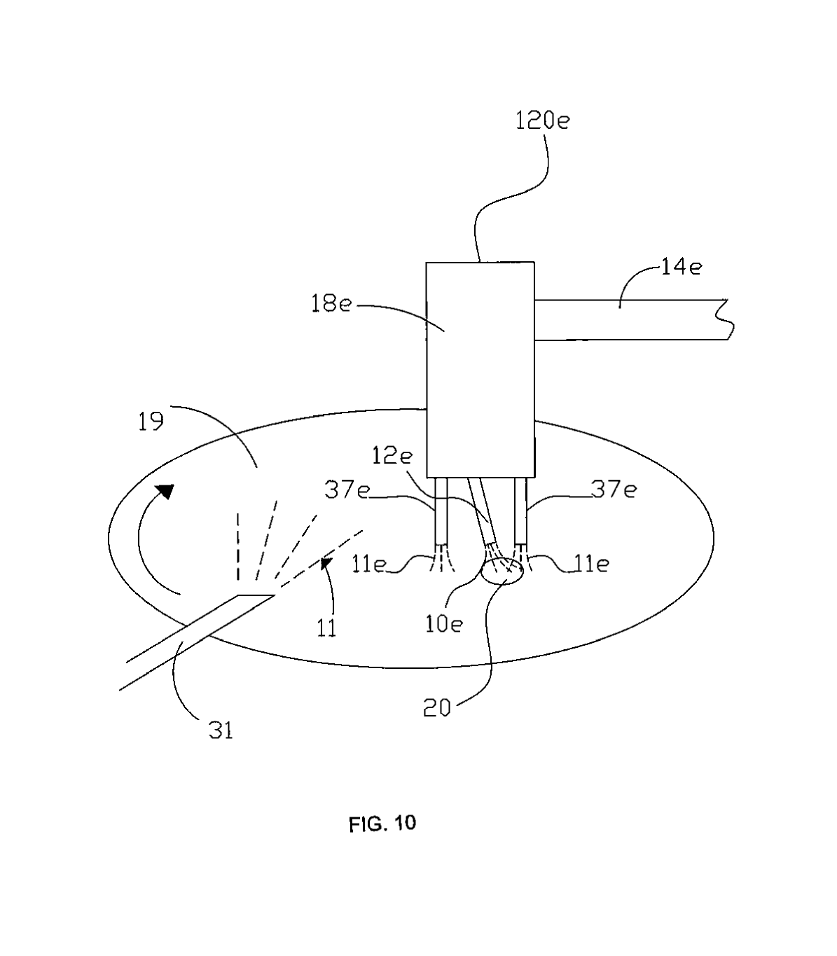

Referring to FIG. 10, a cleaning assembly 120e is illustrated according to another embodiment of the present invention. The cleaning assembly 120e comprises two liquid dispensers 37e and a gas dispenser 12e. The liquid dispensers 37e are positioned on both sides of the gas dispenser 12e. Thus, liquid 11 is applied both forward to and behind the gas dispenser 12e. The gas dispenser 12e is angled with respect to the surface of the substrate 19 so that the gas 10 is dispensed in a direction away from the central axis of the substrate 19 and at a non-normal orientation.

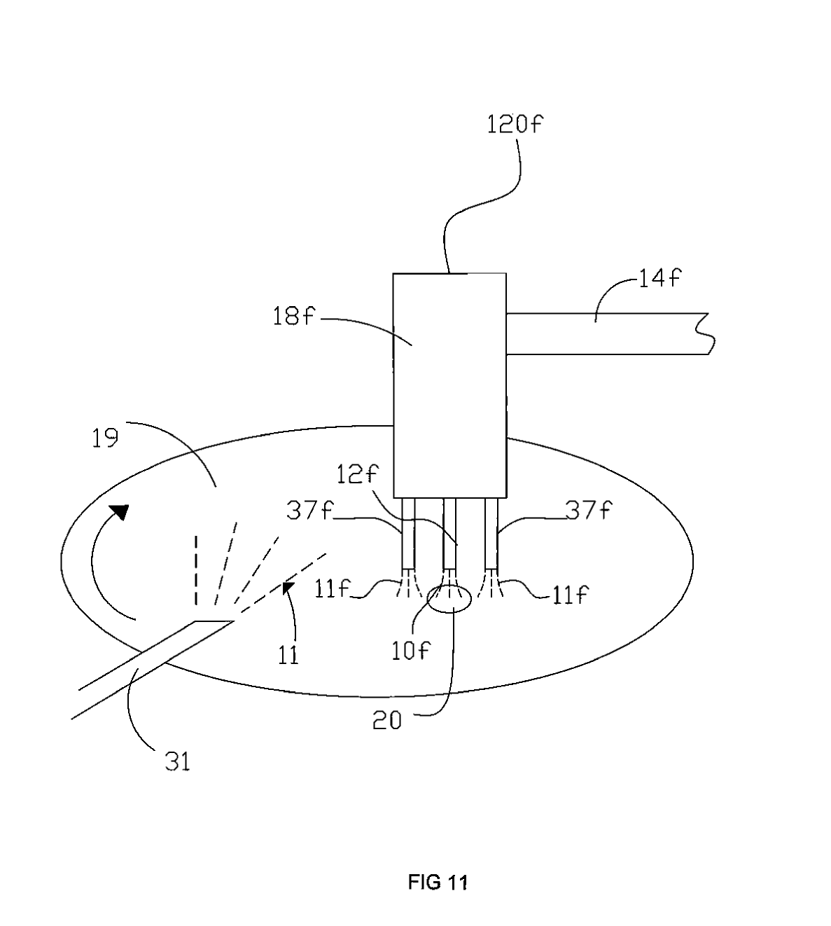

Referring now to FIG. 11, a cleaning assembly 120f is illustrated according to another embodiment of the present invention. The cleaning assembly 120f comprises two liquid dispensers 37f and a gas dispenser 12f. The gas dispenser 12f and the liquid dispensers 37f are perpendicular with respect to the surface of the substrate 19. The liquid dispensers 37f are located on both sides of the gas dispenser 12f. Each liquid dispenser 37f is equidistant from the gas dispenser 12f. The spacing is such that the stream of gas 10 and the liquid 11 do not intersect before striking the surface of the substrate 19. This avoids the creation of accelerated liquid droplets that may damage the delicate devices on the surface of the substrate.

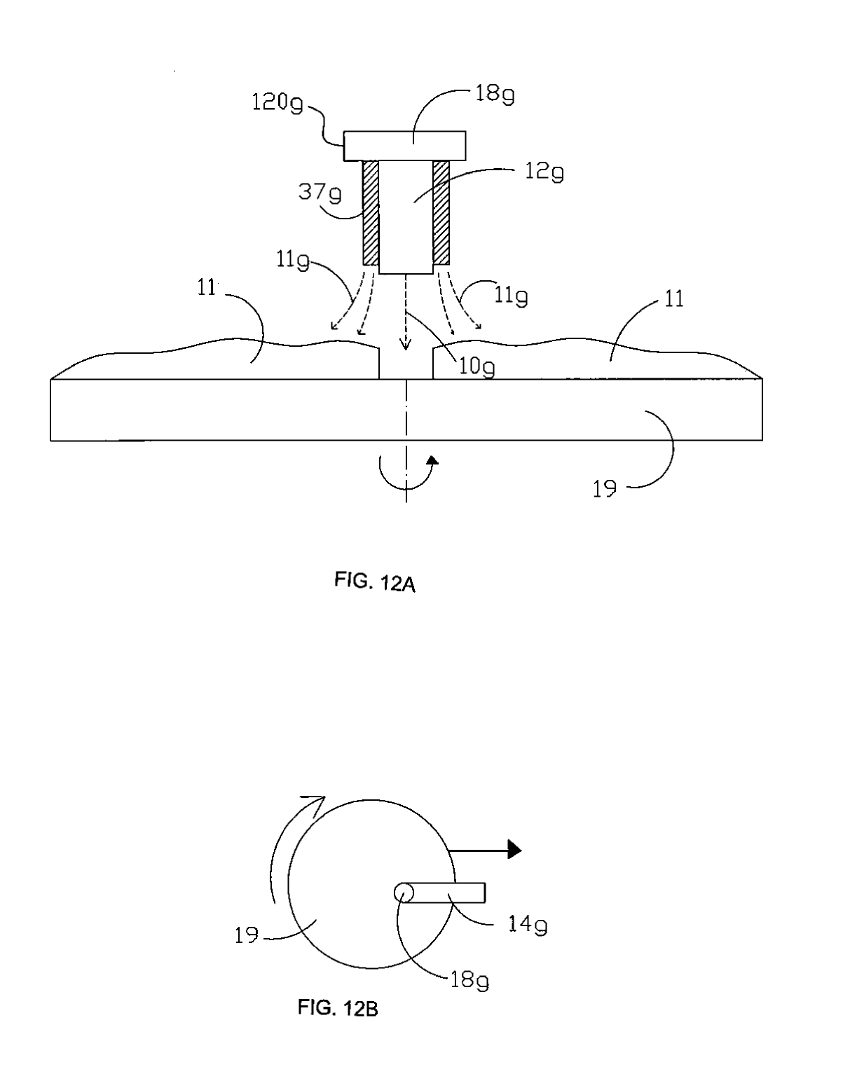

Now turning to FIGS. 12a and 12b, a cleaning assembly 120g is shown according to another embodiment of the present invention. The cleaning assembly 120g comprises a liquid dispenser 37g that circumferentially surrounds the gas dispenser 12g. In other words, the gas dispenser 12g is concentrically located within the liquid dispenser 37g. The liquid dispenser 37g may fully or partially surround the gas dispenser 12g in other embodiments. Surrounding the gas dispenser 12g with the liquid dispenser 37g keeps the surface of the substrate 19 wet during the spinning and sweep movements that take place during the cleaning process, while still enabling the creation of the localized area 20. As high speed spin and sweep processes are used in many cleaning applications, a user is able to maintain the same or analogous process recipes for smaller devices that they would use for larger devices. This technique can be used whether or not a heated gas, non-heated gas, and/or specialty gases (such as etch-related gases) and the like are employed. Furthermore, the cleaning assembly 120g may be used with slow speed movements of the support member 14 and high substrate rotation speeds, or with slow movements of the support member 14 and slow substrate rotation speeds that can be used in order to achieve and maintain good linear versus radial profiles across the substrate 19.

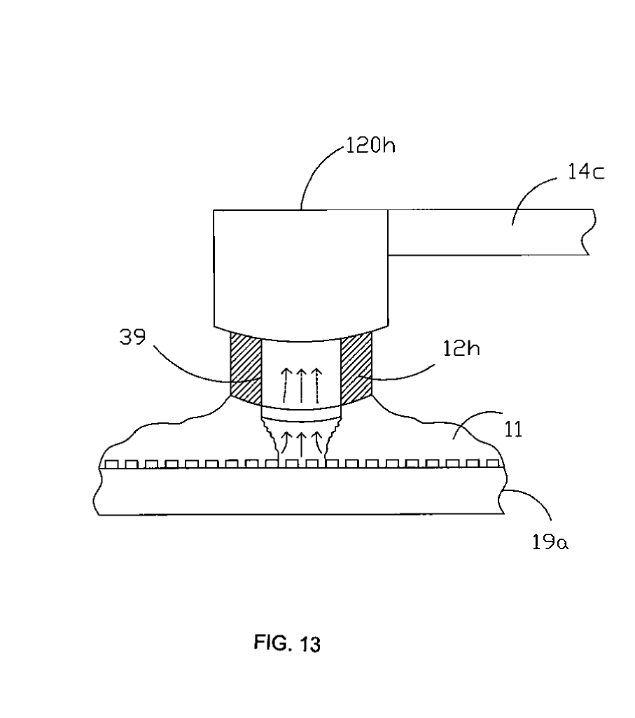

Referring now to FIG. 13, a cleaning assembly 120h is illustrated according to another embodiment of the present invention. The cleaning assembly 120h utilizes a suction force rather than a forced gas stream, to remove particles 8 from the surface of the substrate 19. The suction process comprises positioning the cleaning assembly 120h above the surface of the substrate 19 and rotating the substrate 19. The suction tube 39 is housed within the nozzle of the liquid dispenser 12h. The nozzle of the liquid dispenser 12h has a diameter of between 1.2 to 4 times that of the nozzle of the suction tube 39. The suction assembly 39 is operably coupled to a device that creates a negative pressure that results in a corresponding suction force at the inlet if the suction tube 39. The cleaning assembly 120h is positioned sufficiently close to the top surface of the substrate 19 so that the opening of the suction assembly 39 is in contact with the film of fluid 11.

In operation a liquid 11 is supplied to the surface of the substrate 19 through the liquid dispenser 12h and suction is performed through the suction assembly 39. The liquid 11 forms a thin film as it is dispensed onto the surface of the substrate 19. The suction assembly 39 then applies a localized suction force to the film of liquid 11 so as to break the boundary layer and draw liquid away from the surface of the substrate. As a result, the particles 8 that are caught in the fluid boundary layer, as well as the particles 8 trapped on the nodes 41 and within the trenches 43 get suctioned away from the substrate 19. In some embodiments, the localized suction force will create a localized area 20, which is substantially free of the liquid 11.

The suction assembly 39 and the localized area 20 is translated relative to the surface of the substrate 19 in order to clean all or part of the surface area of the substrate 19. An additional fluid dispenser, such as the liquid dispenser 31 may be used as the suction assembly 39 is operating. It is also understood that the configuration of the suction assembly 39 including but not limited to its angle and the distance of the nozzle ends above the substrate 19, may be varied.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method of processing a substrate comprising the steps of:
a) supporting a substrate on a rotary support;
b) rotating the substrate about a rotational center-point;
c) applying a liquid to a surface of the substrate so as to form a film of the liquid on the surface of the substrate, wherein a boundary layer exists at the interface of the surface and the film of the liquid; and
d) applying a stream of gas to penetrate the boundary layer so as to create a localized area on the surface of the substrate that is substantially free of the liquid, the localized area being surrounded by the film of liquid.

2. The method of claim 1 wherein the substrate is rotated at a speed less than 150 RPMs.

3. The method of claim 1 further comprising:
e) moving the localized area along the surface of the substrate in a radial direction.

4. The method of claim 3 wherein step e) comprises moving the localized area from at or near the rotational center-point to at or near an edge of the substrate.

5. The method of claim 3 wherein the liquid is applied via a first dispenser and the stream of gas is supplied via a second dispenser, and wherein step e) further comprises moving the second dispenser along the surface of the substrate in the radial direction, the second dispenser leading the first dispenser during the radial movement.

6. The method of claim 3 wherein the liquid is applied via a first dispenser and the stream of gas is supplied via a second dispenser, and wherein step e) further comprises moving the second dispenser along the surface of the substrate in the radial direction, the first dispenser leading the second dispenser during the radial movement.

7. The method of claim 1 wherein the liquid is applied via a first dispenser and the stream of gas is applied via a second dispenser, the second dispenser being concentrically located within the first dispenser.

8. The method of claim 1 wherein the stream of gas is applied at a non-perpendicular orientation with respect to the surface of the substrate.

9. The method of claim 1 further comprising providing an assembly having a first dispenser, a second dispenser and a third dispenser positioned between the first and second dispensers, wherein the liquid is applied via the first and second dispensers and the stream of gas is applied via the third dispenser.

10. The method of claim 1 the liquid is heated to a temperature that is above ambient.

11. The method of claim 10 wherein the temperature is greater than or equal to 100° C.

12. The method of claim 1 wherein the gas is selected from the group consisting of nitrogen, CO2, CDA, Argon, Helium, Oxygen, and Ozone.

13. The method of claim 1 wherein the liquid is selected from the group consisting of deionized water, diluted hydrofluoric acid, hydrochloric acid, hydrogen peroxide, ammonia hydroxide, diluted ammonia solution, and combinations thereof.

14. The method of claim 1 further comprising applying sonic energy to the surface of the substrate prior to the application of the gas stream.

15. A method for cleaning a semiconductor wafer comprising:
a) supporting a semiconductor wafer in a substantially horizontal orientation;
b) rotating the semiconductor wafer;
c) applying a liquid to a surface of the substrate so as to form a film of the liquid on the surface of the substrate, wherein a boundary layer exists at the interface of the surface and the film of the liquid;
d) applying sonic energy to the surface of the substrate so as to loosen particles located on the surface of the substrate; and
e) applying a stream of gas that penetrates the boundary layer so as to create a localized area on the surface of the substrate that is substantially free of the liquid, the localized area being surrounded by the film of the liquid and dislodging the particles away from the surface of the substrate.

16. The method of claim 15 wherein the gas is heated.

17. The method of claim 15 wherein the semiconductor wafer has a topography that is less than or equal to 65 nanometers.

18. A method of processing a substrate comprising the steps of:
a) supporting a substrate;
b) rotating the substrate;
c) applying a liquid to a surface of the substrate so as to form a film of the liquid on the surface of the substrate, wherein a boundary layer exists at the interface of the surface and the film of the liquid; and
d) applying a localized suction force to the film of liquid that breaks the boundary layer, thereby drawing liquid away from the surface of the substrate.

19. The method of claim 18 wherein the localized suction force creates a localized area substantially free of the liquid, the localized area being surrounded by the film of the liquid.

20. A system for processing a substrate comprising:
a rotary support for supporting a substrate;
a first dispenser adapted to apply a liquid to a surface of the substrate so as to form a film of the liquid on the surface of the substrate, wherein a boundary layer exists at the interface of the surface of the substrate and the film of the liquid; and
a second dispenser adapted to supply a stream of gas and having an outlet, the second dispenser positioned so that the outlet is sufficiently close to the surface of the substrate so that the stream of gas penetrates the boundary layer so as to create a localized area on the surface of the substrate that is substantially free of the liquid, the localized area being surrounded by the film of liquid.

21. The system of claim 20 wherein the second dispenser is concentrically located within the first dispenser.

22. The system of claim 20 further comprising means for translating the second dispenser above the surface of the substrate.

23. The system of claim 20 wherein the second dispenser is oriented so that the stream of gas is supplied at a non-normal orientation with respect to the surface of the substrate.

24. The system of claim 20 further comprising means for heating the stream of gas prior to exiting the outlet of the second dispenser.

25. The system of claim 1 further comprising a source of gas operably coupled to the second dispenser.

26. The system of claim 25 wherein the gas is selected from the group consisting of nitrogen, CO2, CDA, Argon, Helium, Oxygen, and Ozone.

27. The system of claim 20 further comprising a source of sonic energy positioned adjacent a surface of a substrate positioned on the rotary support.

28. A system for processing a substrate comprising:
a rotary support for supporting a substrate;
a first dispenser adapted to apply a liquid to a surface of the substrate so as to form a film of the liquid on the surface of the substrate, wherein a boundary layer exists at the interface of the surface of the substrate and the film of the liquid; and
a second dispenser adapted to apply a localized suction force and having an opening, the second dispenser positioned so that the opening is sufficiently close to the surface of the substrate so that the opening is contact with the film of liquid.
